(19) United States
(12) Patent Application Publication
(10) Pub. No.: US 2021/0157495 A1
(43) Pub. Date: May 27, 2021

(54) DEVICE AND METHOD FOR CONTROLLING DATA-READING AND -WRITING

(71) Applicant: Industrial Technology Research Institute, Hsinchu (TW)

(72) Inventors: Yu-Chieh CHIU, Taipei City (TW); Ka-Yi YEH, Hsinchu City (TW)

(21) Appl. No.: 16/727,877

(22) Filed: Dec. 26, 2019

(30) Foreign Application Priority Data
Nov. 22, 2019 (TW) 108142452

(51) Int. Cl. G06F 3/06; G06F 12/10

(52) U.S. Cl. CPC G06F 3/0635; G06F 3/0604; G06F 12/10; G06F 3/0631; G06F 3/0659

(57) ABSTRACT

A device for controlling data-reading and -writing includes a memory controller. The memory controller controls the reading and writing of a memory, wherein the memory includes at least a first physical block and a second physical block. The memory controller, upon receives a write request for a data block, duplicately writes mapped data corresponding to data of the data block into mapped positions corresponding to the first physical block and the second physical block according to the write request. The memory controller, upon receives a read request for the data block, selects to read the mapped data corresponding to the data of the data block from the first physical block or the second physical block corresponding to the mapped position according to the read request and a reading condition, to continuously output the data of the data block stored in the memory.

### CROSS-REFERENCE TO RELATED APPLICATION

The present application is based on, and claims priority from, Taiwan Application Serial Number 108142452, filed Nov. 22, 2019, the disclosure of which is hereby incorporated by reference herein in its entirety.

### TECHNICAL FIELD

The present disclosure relates to a device and a method for controlling data-reading and -writing.

### BACKGROUND

In recent years, random access memory (RAM), such as dynamic random access memory (DRAM), have gradually been achieving larger capacity and higher bandwidth. The speed of the internal memory unit of random access memory has not increased, however. One reason is that when the capacity is increased, the number of memory units in the memory matrix is also increased. DRAM is used as an example: the benefits of a smaller process are offset by the larger capacity of the random access memory.

Now that the memory core speed has not increased, but the bandwidth has to be greatly increased, the question becomes: how can this be achieved? In fact, it may be achieved through pre-fetch. That is, a plurality of data are output from the memory each time. Before the I/O controller sends a request, the data are prepared in a pre-fetch queue in advance and then the data are read sequentially, or the data are written into a temporary storage area when writing and then the data are written sequentially. This concept of pre-fetching started in the era of double data rate (DDR). The amount of pre-fetched data of the first generation DDR is two units of data, and now the amount of pre-fetch data of the fourth generation DDR (DDR4) is 8n.

At the same time, DDR4 introduced the concept of a bank group. The bank group is an independent entity. A row cycle is allowed to be completed within the bank group. The row cycle does not affect what happens in another bank group, however. This concept of a bank group is not only found in the DDR4, but also in other advanced memories. After introducing the concept of a bank group, there is a big difference in reading data between the same bank group and different bank groups. The highest bandwidth may be achieved through an appropriate command schedule.

If the data are stored in different bank groups, the operation needs a latency of four clock cycles. However, at a transmission rate of 2133 Mbps, a column command operation performed in the same bank group needs a latency of six clock cycles. This means that there are two clock cycles without data transmission in the six clock cycles, and a bandwidth of 33% is wasted. When the transmission rate is higher, the wasted bandwidth may be up to 50%. Accordingly, DDR4 or the dynamic memory with similar architecture is able to use full-bandwidth, the data needs to be arranged in different bank groups so that it can be alternately accessed.

Therefore, how to effectively and continuously output data, especially data stored in the same bank group when a memory controller is continuously being read, and how to improve the reading speed of the data and/or reduce the reading time of the data have become important issues.

### SUMMARY

The present disclosure provides an embodiment of a device for controlling data-reading and -writing, which includes a memory controller. The memory controller is configured to control the reading and writing of a memory, wherein the memory includes at least a first physical block and a second physical block. The memory controller, upon receives a write request for a data block, duplicately writes mapped data corresponding to data of the data block into a mapped position corresponding to the first physical block and the second physical block according to the write request. The memory controller, upon receives a read request for the data block, selects to read the mapped data corresponding to the data of the data block from the first physical block or the second physical block corresponding to the mapped position according to the read request and a reading condition, to continuously output the data of the data block stored in the memory.

In addition, the present disclosure provides an embodiment of a method for controlling data-reading and -writing, which includes the following steps. Upon receiving a write request for a data block, duplicately writing mapped data corresponding to data of the data block into a mapped position corresponding to the first physical block and the second physical block of a memory according to the write request. Upon receiving a read request for the data block, selecting the mapped data corresponding to the data of the data block to read from the first physical block or the second physical block corresponding to the mapped position according to the read request and a reading condition, to continuously output the data of the data block stored in the memory.

### BRIEF DESCRIPTION OF DRAWINGS

The present disclosure may be more fully understood by reading the subsequent detailed description and examples with references made to the accompanying drawings, wherein:

FIG. 1 is a schematic view of a device for controlling data-reading and -writing according to an embodiment of the present disclosure;

FIG. 2 is a schematic view of a corresponding relationship of a first physical block and a second physical block according to an embodiment of the present disclosure;

FIG. 3 is a schematic view of a memory controller according to an embodiment of the present disclosure;

FIG. 4 is a schematic view of a memory controller according to another embodiment of the present disclosure;

FIGS. 5A-5C are schematic views of a corresponding relationship of a first physical block and a second physical block according to an embodiment of the present disclosure;

FIG. 6 is a flowchart of a method for controlling data-reading and -writing according to an embodiment of the present disclosure; and

FIG. 7 is a flowchart of a method for controlling data-reading and -writing according to an embodiment of the present disclosure.

### DETAILED DESCRIPTION OF DISCLOSED EMBODIMENTS

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, a person skilled in the art would selectively implement all or some technical features of any embodiment of the disclosure or selectively combine all or some technical features of the embodiments of the disclosure.

In each of the following embodiments, the same reference number represents the same or similar element or component.

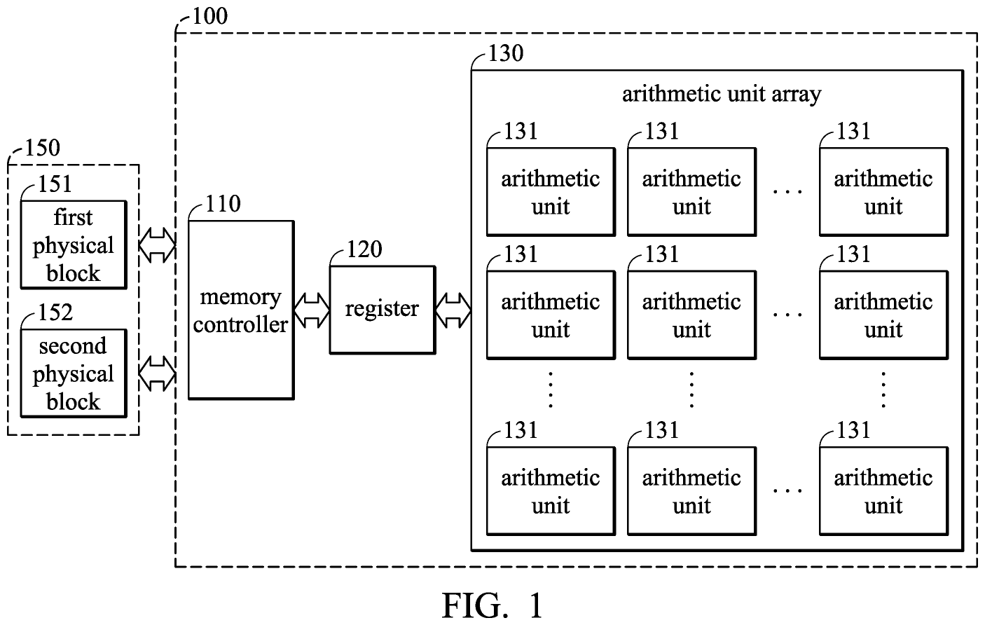

FIG. 1 is a schematic view of a device for controlling data-reading and -writing according to an embodiment of the present disclosure. Please refer to FIG. 1. The device for controlling data-reading and -writing 100 includes at least a memory controller 110, a register 120 and an arithmetic unit array 130.

The memory controller 110 is configured to control the reading and writing of a memory 150, wherein the memory 150 includes a first physical block 151 and a second physical block 152. In the embodiment of the present disclosure, the memory 150 may be a dynamic random access memory (DRAM). In addition, the so-called physical blocks refer to a space set formed by consecutive physical addresses in the memory. The first physical block 151 and the second physical block 152 may be, for example, a memory rank, a chip, a memory module a bank group, or a bank, but the embodiment of the present disclosure is not limited thereto.

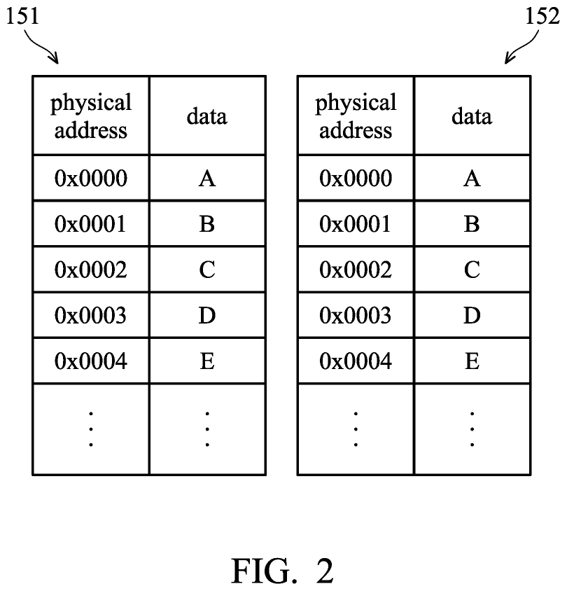

The memory controller 110 receives a write request for a data block, and duplicately writes mapped data corresponding to data of the data block into a mapped position corresponding to the first physical block 151 and the second physical block 152 of the memory 150 according to the write request. In one embodiment, when the memory controller 110 writes the mapped data corresponding to the data of the data block into the first physical block 151 and the second physical block 152, the mapped positions corresponding to the first physical block 151 and the second physical block 152 may have the same mapped data, as shown in FIG. 2. In this embodiment, the mapped data written into the first physical block 151 and the second physical block 152 may be the original data in the data block or transformed data after mapping transformation.

For example, data A may be written into and stored in mapped physical address “0x0000” of the first physical block 151 and the second physical block 152 corresponding to a logical address “0x0000” of the data block. Data B may be written into and stored in mapped physical address “0x0001” of the first physical block 151 and the second physical block 152 corresponding to a logical address “0x0001” of the data block. Data C may be written into and stored in mapped physical address “0x0002” of the first physical block 151 and the second physical block 152 corresponding to a logical address “0x0002” of the data block. The manner of writing the data into and storing the data in other mapped physical addresses of the first physical block 151 and the second physical block 152 corresponding to other logical addresses of the data block may be deduced by analogy from the description of the above embodiment.

The memory controller 110 receives a read request for the data block, and selects to read the mapped data corresponding to the data of the data block from the first physical block 151 or the second physical block 152 corresponding to the mapped position according to the read request and a reading condition to continuously output the data of the data block stored in the memory 150. If the mapped data is the transformed data, the mapped data need to be inverse transformed. In one embodiment, the reading condition may be, for example, a preset alternately reading. For example, when the memory controller 110 receives the read request, the memory controller 110 may first read “the data A” from the mapped physical address “0x0000” of the first physical block 151 according to the read request and the reading condition (i.e., the alternately reading in this embodiment). Then, the memory controller 110 may read “the data B” from the mapped physical address “0x0001” of the second physical block 152. Afterward, the memory controller 110 may read “the data C” from the mapped physical address “0x0002” of the first physical block 151. The manner that the memory controller 110 selects to read the data from other mapped physical addresses of the first physical block 151 or the second physical block 152 corresponding to the mapped position may be deduced by analogy from the description of the above embodiment. That is, the memory controller 110 may alternately read the mapped data corresponding to the data of the data block from the first physical block 151 or the second physical block 152 corresponding to the mapped position. Therefore, the memory controller 110 may continuously read the memory to obtain the mapped data corresponding to the data of the data block, so that the reading speed of the data stored in the physical blocks of the memory 150 may be effectively improved and/or the reading time of the data may be reduced, and the effect of continuously outputting the data stored in the physical blocks of the memory 150 may be achieved.

In another embodiment, the memory controller 110 may read “the data A” from the mapped physical address “0x0000” of the first physical block 151. Then, the memory controller 110 may read “the data B” from the mapped physical address “0x0001” of the second physical block 152. Afterward, the memory controller 110 may read “the data C” from the mapped physical address “0x0002” of the first physical block 151. Then, the memory controller 110 may read “the data A” from the mapped physical address “0x0000” of the second physical block 152. Afterward, the memory controller 110 may read “the data B” from the mapped physical address “0x0001” of the first physical block 151. The manner that the memory controller 110 selects to read other data from other mapped physical addresses of the first physical block 151 or the second physical block 152 corresponding to the mapped position may be deduced by analogy from the description of the above embodiment.

In one embodiment, the reading condition may be, for example, respective states of the first physical block 151 and the physical block 152. That is, when the memory controller 110 reads the data from the first physical block 151 or the second physical block 152 corresponding to the mapped position, the memory controller 110 may determine whether a read latency of the first physical block 151 is less than a read latency of the second physical block 152 according to the obtained respective states of the first physical block 151 and the second physical block 152. For example, an arbiter uses the state of each physical block to calculate and determine the read latency of each mapped physical address, and then selects to read the mapped data corresponding to the data of the data block from the first physical block 151 or the second physical block 152 that the read latency is lower. Herein, the so-called state of the physical block may be, for example, a certain state and counter of a bank state machine. That is, the memory controller 110 may calculate the read latencies of the first physical block 151 and the second physical block 152 according to the certain state or counter of the bank state machine inside the memory controller 110.

When the memory controller 110 determines that the read latency of the first physical block 151 is not greater than the read latency of the second physical block 152, the memory controller 110 may select to read the data from the first physical block 151 of the mapped position. In addition, when the memory controller 110 determines that the read latency of the first physical block 151 is greater than the read latency of the second physical block 152, the memory controller 110 may select to read the data from the second physical block 152 of the mapped position.

For example, when the memory controller 110 receives the read request, the memory controller 110 read “the data A” from the mapped physical address “0x0000” of the first physical block 151 according to the read request and the reading condition (i.e., the respective states of the first physical block 151 and the second physical block 152 in this embodiment). That is, the read latency of the first physical block 151 is less than the read latency of the second physical block 152. Then, the memory controller 110 may read “the data B” from the mapped physical address “0x0001” of the first physical block 151. That is, the read latency of the first physical block 151 is less than the read latency of the second physical block 152.

Afterward, the memory controller 110 may read “the data C” from the mapped physical address “0x0002” of the second physical block 152. That is, the read latency of the first physical block 151 is not less than the read latency of the second physical block 152. Then, the memory controller 110 may read “the data D” from the mapped address “0x0003” of the second physical address 152. That is, the read latency of the first physical block 151 is not less than the read latency of the second physical block 152. Afterward, the memory controller 110 may read the “E” from the mapped physical address “0x0004” of the first physical block 151. That is, the read latency of the first physical block 151 is less than the read latency of the second physical block 152. The manner that the memory controller 110 selects to read the data from other mapped physical addresses of the first physical block 151 or the second physical block 152 corresponding to the mapped position may be deduced by analogy from the description of the above embodiment. Therefore, the memory controller 110 may continuously read to output the data of the data block, so that the reading time of the data may be reduced, and the effect of continuously outputting the mapped data corresponding to the data of the data block stored in the memory may be achieved.

The register 120 temporarily store data read from the memory 150 or written into the memory 150. The arithmetic unit array 130 performs a mathematical operation on the data temporarily stored in the register 120, wherein the arithmetic unit array 130 includes a plurality of arithmetic units 131 for performing mathematical operations, such as a multiplication and addition operation, etc.

In another embodiment, the memory controller 110 may read “the data A” from the mapped physical address “0x0000” of the first physical block 151. Then, the memory controller 110 may read “the data D” from the mapped physical address “0x0003” of the second physical block 152. Afterward, the memory controller 110 may read “the data B” from the mapped physical address “0x0001” of the first physical block 151. Then, the memory controller 110 may read “the data E” from the mapped physical address “0x0004” of the first physical block 151. Afterward, the memory controller 110 may read “the data C” from the mapped physical address “0x0002” of the second physical block 152. The manner that the memory controller 110 selects to read the data from other mapped physical addresses of the first physical block 151 or the second physical block 152 corresponding to the mapped position may be deduced by analogy from the description of the above embodiment.

Furthermore, for convenience of explanation, the memory 150 in FIG. 1 includes only two physical blocks, that is, the first physical block 151 and the second physical block 152, but the embodiment of the present disclosure is not limited thereto. The memory 150 may include three or more than three physical blocks. That is, the present disclosure may also associate three or more than three physical block. The reading and writing manner of the memory controller 110 for three or more than three physical blocks may refer to the description of the above embodiment and the same effect may be achieved, and the description thereof is not repeated herein.

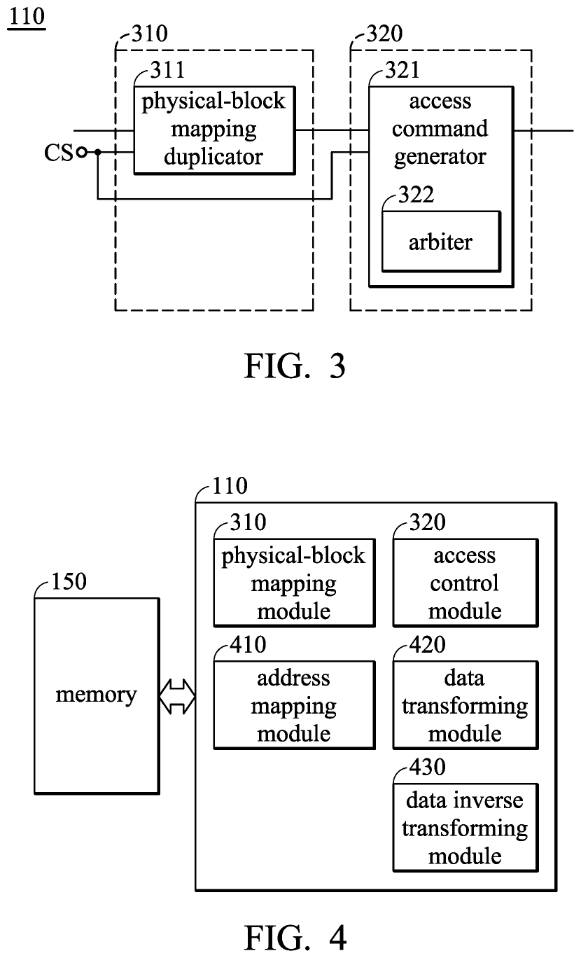

FIG. 3 is a schematic view of a memory controller according to an embodiment of the present disclosure. Please refer to FIG. 3. The memory controller 110 includes a physical-block mapping module 310 and an access control module 320.

The physical-block mapping module 310 includes a physical-block mapping duplicator 311. The physical-block mapping duplicator 311 maps the logical address of the data block into a first physical address and a second physical address according to a control signal CS, wherein the first physical address is the mapped position of the first physical block 151, and the second physical address is the mapped position of the second physical block 152. For example, when the control signal CS is, for example, a high logic level, the physical-block mapping duplicator 311 maps the logical address of the data block into the first physical address and the second physical address. When the control signal CS is, for example, a low logic level, the physical-block mapping duplicator 311 may not map the logical address of the data block into the first physical address and the second physical address, and only map the logical address of the data block into single physical address.

The access control module 320 includes an access command generator 321. The access command generator 321 duplicately writes the mapped data corresponding to the data of the data block into the mapped position corresponding to the first physical block 151 and the second physical block 152 according to the control signal CS, the first physical address and the second physical address. The access command generator 321 selects to read the mapped data corresponding to the data of the data block from the first physical block 151 or the second physical block 152 corresponding to the mapped position according to the control signal CS, the reading condition, the first physical address and the second physical address.

For example, when the control signal CS is a high logic level, the access command generator 321 writes the data of the data block into the mapped position corresponding to the first physical block 151 and the second physical block 152, and selects to read the mapped data corresponding to the data of the data block from the first physical block 151 or the second physical block 152 corresponding to the mapped position according to the first physical address and the second physical address. When the control signal CS is a low logic level, the access command generator 321 does not operate or only accesses one of the first physical address and the second physical address. For example, the access command generator 321 only accesses the first physical address.

Furthermore, when the reading condition includes respective states of the first physical block and the second physical block, the access command generator 321 may include an arbiter 322. The arbiter 322 may select to read the mapped data corresponding to the data of the data block from the first physical block 151 or the second physical block 152 that has a lower calculated read latency.

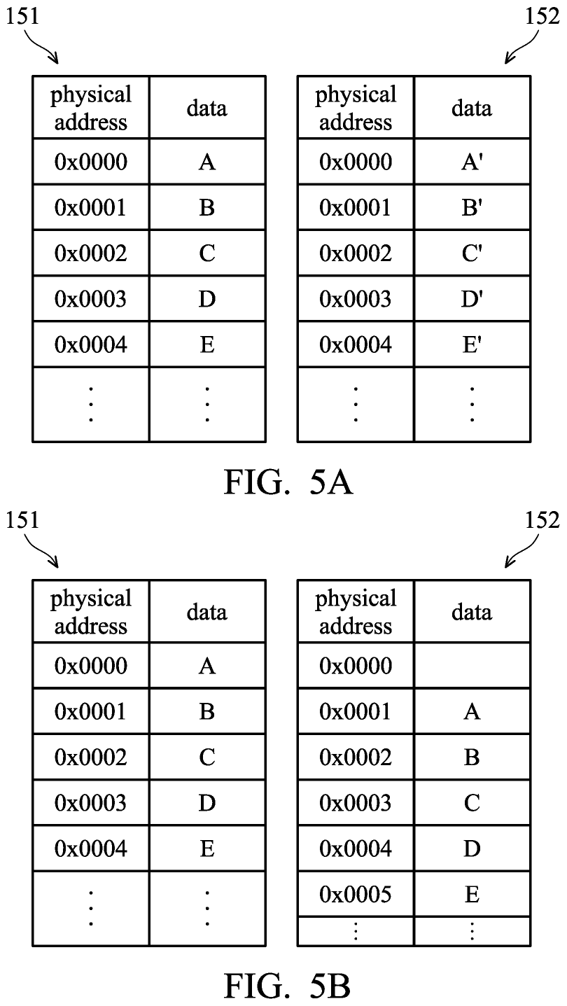

FIG. 4 is a schematic view of a memory controller according to another embodiment of the present disclosure. Please to refer to FIG. 4. The memory controller 110 further includes an address mapping module 410, a data transforming module 420 and a data inverse transforming module 430.

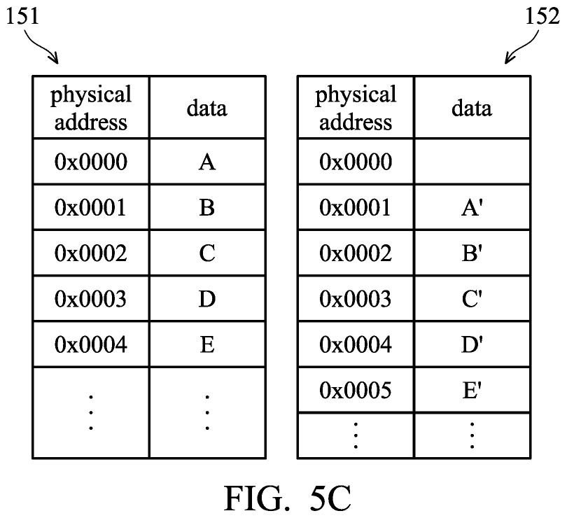

As mentioned, the memory controller 110 receives the write request for the data block, and duplicately writes the mapped data corresponding to the data of the data block into the mapped position corresponding to the first physical block 151 and the second physical block 152 according to the write request. In another embodiment, the data transforming module 420 may transform the mapped data written into the second physical block. For example, the data transforming module 420 transforms the mapped data corresponding to the data of the data block of the first physical block 151 into transformed data, as shown in FIG. 5A. In the embodiment, the mapped data written into the first physical block 151 may be real data of the data block or first transformed data after transforming, and the mapped data written into the second physical block 152 may be second transformed data obtained by transforming the mapped data written into the first physical block 151. Furthermore, the mapping and transforming manner of different physical blocks may be the same or different.

For example, the data transforming module 420 may transform the data A corresponding to the mapped physical address “0x0000” of the first physical block 151 into transformed data A′, and the transformed data A′ may be written into the mapped position corresponding to the second physical block 152 (such as the mapped physical address “0x0000” of the second physical block 152). The data transforming module 420 may transform the data B corresponding to the mapped physical address “0x0001” of the first physical block 151 into transformed data B′, and the transformed data B′ may be written into the mapped position corresponding the second physical block 152 (such as the mapped physical address “0x0001” of the second physical block 152). The data transforming module 420 may transform the data C corresponding to the mapped physical address “0x0002” of the first physical block 151 into transformed data C′, and the transformed data C′ may be written into the mapped position corresponding to the second physical block 152 (such as the mapped physical address “0x0002” of the second physical block 152). The manner that the data transforming module 420 transforms other data into other transformed data may be deduced by analogy from the description of the above embodiment.

The memory controller 110 selects to read the mapped data corresponding to the data of the data block from the first physical block 151 corresponding to the mapped position or selects to read original data from second physical block 152 corresponding to the mapped position after the data inverse transforming module 430 inversely transforms the transformed data written into mapped position of the second physical block 152 into the original data according to the read request and the reading condition, so as to continuously read to obtain the mapped data corresponding to the data of the data block stored in the memory 150.

For example, when the memory controller 110 reads the transformed data A′ from the mapped physical address “0x0000” of the second physical block 152, the data inverse transforming module 430 may inversely transform the transformed data A′ of the mapped physical address “0x0000” of the second physical block 152 into the data A (i.e., the original data), so that the memory controller 110 reads the data A (i.e., the original data) from the mapped physical address “0x0000” of the second physical block 152. When the memory controller 110 reads the transformed data B′ from the mapped physical address “0x0001” of the second physical block 152 , the data inverse transforming module 430 may inversely transform the transformed data B′ of the mapped physical address “0x0001” of the second physical block 152 into the data B (i.e., the original data), so that the memory controller 110 reads the data B (i.e., the original data) from the mapped physical address “0x0001” of the second physical block 152. When the memory controller 110 reads the transformed data C′ from the mapped physical address “0x0002” of the second physical block 152, the data inverse transforming module 430 may inversely transform the transformed data C′ of the mapped physical address “0x0002” of the second physical block 152 into the data C (i.e., the original data), so that the memory controller 110 reads the data C (i.e., the original data) from the mapped physical address “0x0002” of the second physical block 152. The manner that the data inverse transforming module 430 inversely transforms other transformed data into other original data may be deduced by analogy from the description of the above embodiment.

As mentioned, the memory controller 110 receives the write request for the data block, and duplicately writes the mapped data corresponding to the data of the data block into the first physical block 151 and the second physical block 152 according to the write request. In another embodiment, the address mapping module 410 maps the mapped physical address of the first physical block 151 into a mapping address, and writes the mapped data corresponding to the data of the data block into the mapped position of the second physical block 152 corresponding to the mapping address, as shown in FIG. 5B.

For example, the address mapping module 410 maps the mapped physical address “0x0000” of the first physical block 151 into a mapping address, for example, corresponding to the mapped physical address “0x0001” of the second physical block 152. Then, the data A may be written into the mapped position of the second physical block 152 corresponding to the mapping address (i.e., the mapped physical address “0x0001” of the second physical block 152. The address mapping module 410 maps the mapped physical address “0x0001” of the first physical block 151 into a mapping address, for example, corresponding to the mapped physical address “0x0002” of the second physical block 152. Then, the data B may be written into the mapped position of the second physical block 152 corresponding to the mapping address (i.e., the mapped physical address “0x0002” of the second physical block 152). The address mapping module 410 maps the mapped physical address “0x0002” of the first physical block 151 into a mapping address, for example, corresponding to the mapped physical address “0x0003” of the second physical block 152. Then, the data C may be written into the mapped position of the second physical block 152 corresponding to the mapping address (i.e., the mapped physical address “0x0003” of the second physical block 152. The manner that the address mapping module 410 maps other mapped physical addresses of the first physical block 151 into other mapping addresses may be deduced by analogy from the description of the above embodiment.

The memory controller 110 selects to read the mapped data corresponding to the data of the data block from the first physical block 151 of the mapped position or read the mapped data corresponding to the data of the data block from the second physical block 152 of the mapped position corresponding to the mapping address according to the read request and the reading condition to continuously read and obtain the mapped data corresponding to the data of the data block stored in the memory 150.

For example, when the memory controller 110 reads the data A from the mapped physical address “0x0001” of the second physical block 152, the address mapping module 410 may map the mapped physical address “0x0000” of the first physical block 151 into a mapping address (for example, corresponding to the mapped physical address “0x0001” of the second physical block 152, so that the memory controller 110 reads the data A from the mapped physical address “0x0001” of the second physical block 152 corresponding to the mapping address “0x0001”. When the memory controller 110 reads the data B from the mapped physical address “0x0002” of the second physical block 152, the address mapping module 410 may map the mapped physical address “0x0001” of the first physical block 151 into a mapping address (for example, corresponding to the mapped physical address “0x0002” of the second physical block 152), so that the memory controller reads the data B from the mapped physical address “0x0002” of the second physical block 152 corresponding to the mapping address “0x0002”.

When the memory controller 110 reads the data C from the mapped physical address “0x0003” of the second physical block 152, the address mapping module 410 may map the mapped physical address “0x0002” of the first physical block 151 into a mapping address (for example, corresponding to the mapped physical address “0x0003” of the second physical block 152), so that the memory controller 110 reads the data C from the mapped physical address “0x0003” of the second physical block 152 corresponding to the mapping address “0x0003”. The manner that the address mapping module 410 maps other mapped physical addresses of the first physical block 151 into other mapping addresses may be deduced by analogy from the description of the above embodiment.

As mentioned, the memory controller 110 receives the write request for the data block, and duplicately writes the mapped data corresponding to the data of the data block into the mapped position corresponding to the first physical block 151 and the second physical block 152 according to the write request. In another embodiment, the address mapping module 410 may map the mapped physical address of the first physical block 151 into a mapping address, and the data transforming module 420 may transform the mapped data written into the second physical block 152. For example, the mapped data corresponding to the data of the data block of the first physical block 151 is transformed into transformed data, as shown in FIG. 5C.

For example, the data transforming module 420 transforms the data A of the mapped physical address “0x0000” of the first physical block 151 into the transformed data A′, and the address mapping module 410 maps the mapped physical address “0x0000” of the first physical block 151 into the mapping address, for example, corresponding to the mapped physical address “0x0001” of the second physical block 152. Then, the transformed data A′ may be written into the mapped position of the second physical block 152 corresponding to the mapping address (i.e., the mapped physical address “0x0001” of the second physical block 152).

The data transforming module 420 transforms the data B of the mapped physical address “0x0001” of the first physical block 151 into the transformed data B′, and the address mapping module 410 maps the mapped physical address “0x0001” of the first physical block 151 into the mapping address, for example, corresponding to the mapped physical address “0x0002” of the second physical block 152. Then, the transformed data B′ may be written into the mapped position of the second physical block 152 corresponding to the mapping address (i.e., the mapped physical address “0x0002” of the second physical block 152). The data transforming module 420 transforms the data C of the mapped physical address “0x0002” of the first physical block 151 into the transformed data C′, and the address mapping module 410 maps the mapped physical address “0x0002” of the first physical block 151 into the mapping address, for example, corresponding to the mapped physical address “0x0003” of the second physical block 152. Then, the transformed data C′ may be written into the mapped position of the second physical block 152 corresponding to the mapped address (i.e., the mapped physical address “0x0003” of the second physical block 152). The manner that the data transforming module 420 transforms other data into other transformed data and the address mapping module 410 maps other mapped physical addresses of the first physical block 151 into other mapping addresses may be deduced by analogy from the description of the above embodiment.

The memory controller 110 may select to read the mapped data corresponding to the data of the data block from the first physical block 151 corresponding to the mapped position, or select to read transformed data of the mapped data from the second physical block 152 of the mapped position corresponding to the mapping address and then the transformed data written into the mapped position of the second physical block 152 corresponding to the mapping address is inversely transformed into the original data through the data inverse transforming module 430 according to the read request and the reading condition, so as to continuously read to obtain the mapped data corresponding to the data of the data block stored in the memory 150.

For example, when the memory controller 110 reads the data A of the second physical block 152, the address mapping module 410 may map the mapped physical address “0x0000” of the first physical block 151 into the mapping address (for example, corresponding to the mapped physical address “0x0001” of the second physical block 152). Then, the data inverse transforming module 430 may inversely transform the transformed data A′ corresponding to the mapped physical address “0x0001” of the second physical block 152 into the data A (i.e., the original data), so that the memory controller 110 reads the data A (i.e., the original data) from the mapped physical address “0x0001” of the second physical block 152 corresponding to the mapping address “0x0001”.

When the memory controller 110 reads the data B of the second physical block 152, the address mapping module 410 may map the mapped physical address “0x0001” of the first physical block 151 into the mapping address (for example, corresponding to the mapped physical address “0x0002” of the second physical block 152). Then, the data inverse transforming module 430 may inversely transform the transformed data B′ of the mapped physical address “0x0002” of the second physical block 152 into the data B (i.e., the original data), so that the memory controller 110 reads the data B (i.e., the original data) from the mapped physical address “0x0002” of the second physical address 152 corresponding to the mapping address “0x0002”. When the memory controller 110 reads the data C of the second physical block 152, the address mapping module 410 may map the mapped physical address “0x0002” of the first physical block 151 into the mapping address (for example, corresponding to the mapped physical address “0x0003” of the second physical block 152). Then, the data inverse transforming module 430 may inversely transform the transformed data C′ of the mapped physical address “0x0003” of the second physical block 152 into the data C (i.e., the original data), so that the memory controller 110 reads the data C (i.e., the original data) from the mapped physical address “0x0003” of the second physical block 152 corresponding to the mapping address “0x0003”. The manner that address mapping module 410 maps other mapped physical addresses into other mapping addresses and the data inverse transforming module 430 inversely transforms other transformed data into other original data may be deduced by analogy from the description of the above embodiment.

In the embodiment of the present disclosure, the data transforming module 420 uses, for example, different algorithms to transform the mapped data corresponding to the data of the data block into different transformed data. In addition, the data inverse transforming module 430 uses, for example, different algorithms to inversely transform the transformed data into the original data.

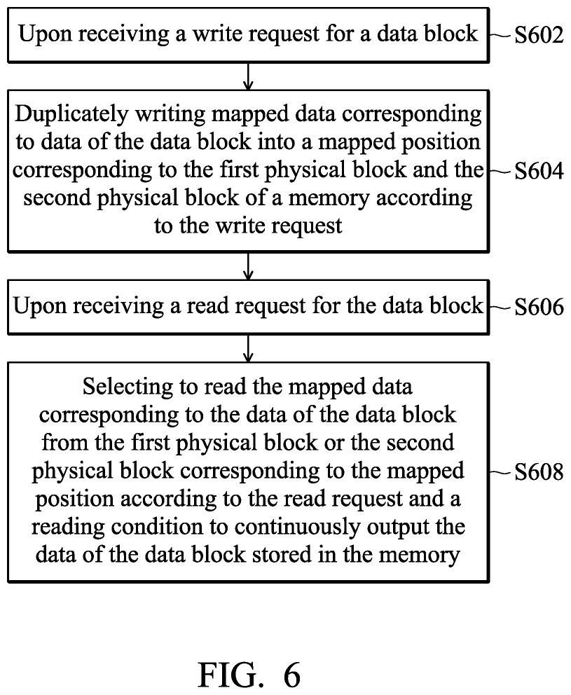

FIG. 6 is a flowchart of a method for controlling data-reading and -writing according to an embodiment of the present disclosure. In step S602, the method involves upon receiving a write request for a data block. In step S604, the method involves duplicately writing mapped data corresponding to data of the data block into a mapped position corresponding to the first physical block and the second physical block of a memory according to the write request. In step S606, the method involves upon receiving a read request for the data block. In step S608, the method involves selecting to read the mapped data corresponding to the data of the data block from the first physical block or the second physical block corresponding to the mapped position according to the read request and a reading condition to continuously output the data of the data block stored in the memory. In the embodiment, the first physical block and the second physical block are a memory rank, a chip, a memory module, a bank group, or a bank. In addition, the reading condition may include preset alternately reading the first physical block and the second physical block, or the respective states of the first physical block and the second physical block.

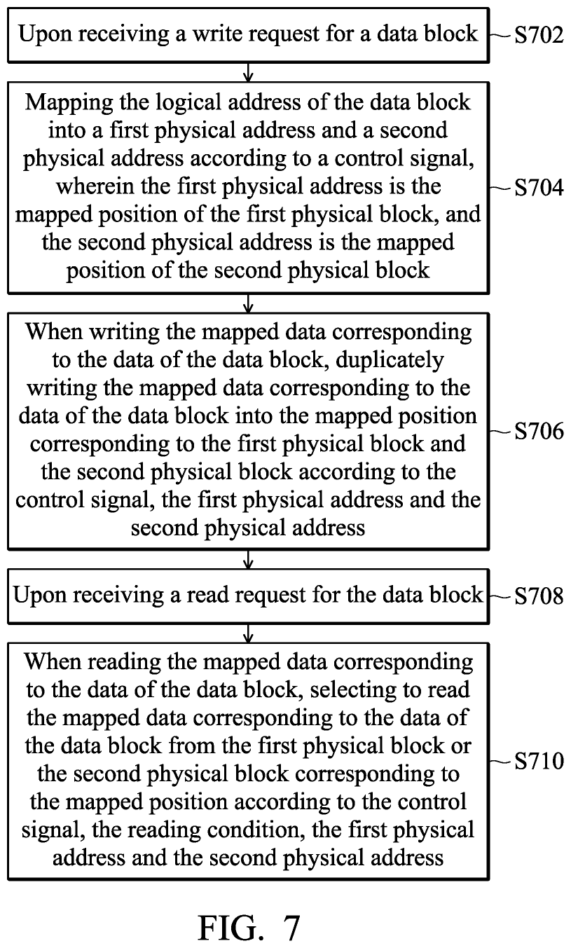

FIG. 7 is a flowchart of a method for controlling data-reading and -writing according to an embodiment of the present disclosure. In step S702, the method involves upon receiving a write request for a data block. In step S704, the method involves mapping the logical address of the data block into a first physical address and a second physical address according to a control signal, wherein the first physical address is the mapped position of the first physical block, and the second physical address is the mapped position of the second physical block.

In step S706, the method involves the following: when writing the mapped data corresponding to the data of the data block, duplicately writing the mapped data corresponding to the data of the data block into the mapped position corresponding to the first physical block and the second physical block according to the control signal, the first physical address and the second physical address. In step S708, the method involves upon receiving a read request for the data block. In step S710, the method involves the following: when reading the mapped data corresponding to the data of the data block, selecting to read the mapped data corresponding to the data of the data block from the first physical block or the second physical block corresponding to the mapped position according to the control signal, the reading condition, the first physical address and the second physical address. In the embodiment, the first physical block and the second physical block are a memory rank, a chip, a memory module, a bank group, or a bank. In addition, the reading condition may include preset alternately reading the first physical block and the second physical block, or the respective states of the first physical block and the second physical block. Furthermore, when the reading condition includes the respective states of the first physical block and the second physical block, the step S710 may further involve selecting to read the mapped data corresponding to the data of the data block from the first physical block or the second physical block that has a lower calculated read latency.

Moreover, when writing the mapped data corresponding to the data of the data block of step S706 and when reading the mapped data corresponding to the data of the data block of step S710, the first physical address and/or the second physical address may be a mapping address mapped by an address mapping module.

Furthermore, the mapped data corresponding to the data of the data block written into the first physical address and/or the second physical address may be transformed data transformed by a data transforming module. The mapped data corresponding to the data of the data block read from the first physical address and/or the second physical address may be original data transformed by a data inverse transforming module. In addition, the data transforming module uses different algorithms to transform the mapped data corresponding to the data of the data block into different transformed data, and the data inverse transforming module uses different algorithms to inversely transform the transformed data into the original data.

In summary, according to the device and the method for controlling data-reading and -writing disclosed by the present disclosure, the memory controller duplicately writes the mapped data corresponding to the data of the data block into the mapped position corresponding to the first physical block and the second physical block according to the write request for the data block, and selects to read the mapped data corresponding to the data of the data block from the first physical block or the second physical block corresponding to the mapped position according to the read request for the data block and the reading condition to continuously read the mapped data corresponding to the data of the data block stored in the memory. In addition, the reading condition may include one of the following: alternately reading the first physical block and the second physical block, or the respective states of the first physical block and the second physical block. Therefore, the reading speed of the data stored in the physical blocks of the memory may be effectively improved and/or the reading time of the data may be reduced, and the effect of continuously outputting the data stored in the physical blocks of the memory may be achieved.

While the disclosure has been described by way of example and in terms of the embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A device for controlling data-reading and -writing, comprising:
a memory controller, configured to control reading and writing of a memory, wherein the memory includes at least a first physical block and a second physical block;
the memory controller, upon receives a write request for a data block, duplicately writes mapped data corresponding to data of the data block into a mapped position corresponding to the first physical block and the second physical block according to the write request; and
the memory controller, upon receives a read request for the data block, selects to read the mapped data corresponding to the data of the data block from the first physical block or the second physical block corresponding to the mapped position according to the read request and a reading condition, to continuously output the data of the data block stored in the memory.

2. The device for controlling data-reading and -writing as claimed in claim 1, wherein the first physical block and the second physical block are a memory rank, a chip, a memory module, a bank group, or a bank.

3. The device for controlling data-reading and -writing as claimed in claim 1, wherein the memory controller further comprises:
a physical-block mapping module, comprising a physical-block mapping duplicator, wherein the physical-block mapping duplicator maps a logical address of the data block into a first physical address and a second physical address according to a control signal, the first physical address is the mapped position of the first physical block, and the second physical address is the mapped position of the second physical block; and
an access control module, comprising an access command generator, wherein the access command generator duplicately writes the mapped data corresponding to the data of the data block into the mapped position corresponding to the first physical block and the second physical block according to the control signal, the first physical address and the second physical address, and the access control module selects to read the mapped data corresponding to the data of the data block from the first physical block or the second physical block corresponding to the mapped position according to the control signal, the reading condition, the first physical address and the second physical address.

4. The device for controlling data-reading and -writing as claimed in claim 3, wherein when the mapped data corresponding to the data of the data block is written and the mapped data corresponding to the data of the data block is read, the first physical address and/or the second physical address are a mapping address mapped by an address mapping module.

5. The device for controlling data-reading and -writing as claimed in claim 3, wherein the mapped data corresponding to the data of the data block written into the first physical address and/or the second physical address are transformed data transformed by a data transforming module, and the mapped data corresponding to the data of the data block read from the first physical address and/or the second physical address are original data transformed by a data inverse transforming module.

6. The device for controlling data-reading and -writing as claimed in claim 5, wherein the data transforming module uses different algorithms to transform the mapped data corresponding to the data of the data block into different transformed data, and the data inverse transforming module uses different algorithms to inversely transform the transformed data into the original data.

7. The device for controlling data-reading and -writing as claimed in claim 3, wherein the reading condition comprises respective states of the first physical block and the second physical block, and the access command generator further comprises an arbiter, and the arbiter selects to read the mapped data corresponding to the data of the data block from the first physical block or the second physical block that has a lower calculated read latency.

8. The device for controlling data-reading and -writing as claimed in claim 1, further comprising:
a register, temporarily storing data read from the memory or written into the memory; and
an arithmetic unit array, performing a mathematical operation on the data temporarily stored in the register, wherein the arithmetic unit array comprises a plurality of arithmetic units for performing mathematical operations.

9. The device for controlling data-reading and -writing as claimed in claim 1, wherein the reading condition comprises alternately reading the first physical block and the second physical block, or respective states of the first physical block and the second physical block.

10. A method for controlling data-reading and -writing, comprising:
upon receiving a write request for a data block, duplicately writing mapped data corresponding to data of the data block into a mapped position corresponding to a first physical block and a second physical block of a memory according to the write request; and
upon receiving a read request for the data block, selecting to read the mapped data corresponding to the data of the data block from the first physical block or the second physical block corresponding to the mapped position according to the read request and a reading condition, to continuously output the data of the data block stored in the memory.

11. The method for controlling data-reading and -writing as claimed in claim 10, wherein the first physical block and the second physical block are a memory rank, a chip, a memory module, a bank group, or a bank.

12. The method for controlling data-reading and -writing as claimed in claim 10, further comprising:
mapping a logical address of the data block into a first physical address and a second physical address according to a control signal, wherein the first physical address is the mapped position of the first physical block, and the second physical address is the mapped position of the second physical block;
when writing the mapped data corresponding to the data of the data block, duplicately writing the mapped data corresponding to the data of the data block into the mapped position corresponding to the first physical block and the second physical block according to the control signal, the first physical address and the second physical address; and
when reading the mapped data corresponding to the data of the data block, selecting to read the mapped data corresponding to the data of the data block from the first physical block or the second physical block corresponding to the mapped position according to the control signal, the reading condition, the first physical address and the second physical address.

13. The method for controlling data-reading and -writing as claimed in claim 12, wherein when writing the mapped data corresponding to the data of the data block and reading the mapped data corresponding to the data of the data block, the first physical address and/or the second physical address are a mapping address mapped by an address mapping module.

14. The method for controlling data-reading and -writing as claimed in claim 12, wherein the mapped data corresponding to the data of the data block written into the first physical address and/or the second physical address are transformed data transformed by a data transforming module, and the mapped data corresponding to the data of the data block read from the first physical address and/or the second physical address are original data transformed by a data inverse transforming module.

15. The method for controlling data-reading and -writing as claimed in claim 14, wherein the data transforming module uses different algorithms to transform the mapped data corresponding to the data of the data block into different transformed data, and the data inverse transforming module uses different algorithms to inversely transform the transformed data into the original data.

16. The method for controlling data-reading and -writing as claimed in claim 12, wherein the reading condition comprises respective states of the first physical block and the second physical block, and selecting to read the mapped data corresponding to the data of the data block from the first physical block or the second physical block that has a lower calculated read latency.

17. The method for controlling data-reading and -writing as claimed in claim 10, wherein the reading condition comprises alternately reading the first physical block and the second physical block, or respective states of the first physical block and the second physical block.
